(19) United States
(12) Patent Application Publication
(10) Pub. No.: US 2007/0078221 A1
(43) Pub. Date: Apr. 5, 2007

(54) Thermoplastic resin composition and method for preparing the same

(76) Inventors: Jeong-su Choi, Yuseong-gu (KR); Hyong-min Bahn, Yeosu-si (KR); Mi-young Lee, Seoul (KR); Won-seok Lee, Yeosu-si (KR); Keun-hoon Yoo, Yeosu-si (KR)

Correspondence Address: CANTOR COLBURN, LLP, 55 GRIFFIN ROAD SOUTH, BLOOMFIELD, CT, 06002, US

(21) Appl. No.: 11/512,452

(22) Filed: Aug. 30, 2006

(30) Foreign Application Priority Data
Aug. 30, 2005 (KR) 10-2005-0080019

(51) Int. Cl. C08L 51/00

(52) U.S. Cl. 525/70

(57) ABSTRACT

The present invention relates to a thermoplastic resin composition and a preparation method of the same, and more precisely a thermoplastic resin having excellent impact strength, surface gloss, and beautiful color, as well as a high level of hardness and scratch resistance, which comprises a) a primary graft copolymer prepared by polymerization of conjugated diene rubber latex with (metha)acrylic acid alkyl ester compound, aromatic vinyl compound and vinyl cyan compound; and b) a secondary copolymer prepared by polymerization of (metha)acrylic acid alkyl ester compound with aromatic vinyl compound and vinyl cyan compound.

This application claims the benefit of the filing date of Korean Patent Application No. 10-2005-0080019 filed on Aug. 30, 2005 in the Korean Intellectual Property Office, the disclosure of which is incorporated herein in its entirety by reference.

### TECHNICAL FIELD

The present invention relates to a thermoplastic resin composition and a method for preparing the same, and more precisely, a thermoplastic resin composition with high hardness which has excellent scratch resistance, impact strength, surface gloss, and beautiful color, and a method for preparing the same.

### BACKGROUND ART

Acryl-butadiene-styrene (ABS) resin has been widely used for the housing (exterior) of electrical appliances owing to its excellent mechanical properties including excellent impact strength and plasticity.

Generally ABS resin has poor scratch resistance, therefore it requires coating to enhance its scratch resistance.

Coating is a convenient and necessary process for the housing material of appliances since it enhances scratch resistance and may help improve the exterior appearance of a product. However, the coating process might cause environmental problems and a coated product is difficult to recycle.

With the increasing concern for the environment, environment-related regulations and controls have been tightened, making recycling one of the most important worldwide environmental issues, and accordingly coatings on resins are limited more and more.

Therefore, it is necessary to develop a resin having excellent scratch resistance without the need for coating, and furthermore, a resin which can be applied to the exterior of appliances with enhanced high gloss and impact strength.

### DISCLOSURE OF THE INVENTION

It is an object of the present invention, to overcome the above problems, to provide a thermoplastic resin composition with high hardness which has excellent scratch resistance, impact strength, surface gloss and beautiful color, without the need for coating.

It is another object of the present invention to provide a method for preparing the thermoplastic resin composition.

To achieve the above objects, the present invention provides a thermoplastic resin composition containing a) a primary graft copolymer prepared by graft-copolymerization of conjugated diene rubber latex with (metha)acrylic acid alkyl ester compound, aromatic vinyl compound and vinyl cyan compound, and having a weight average molecular weight of 80,000-300,000; and b) a secondary copolymer prepared by the polymerization of (metha)acrylic acid alkyl ester compound, aromatic vinyl compound and vinyl cyan compound, and having a weight average molecular weight of 80,000-300,000, in which the weight average molecular weight of the mixture of the primary copolymer and the secondary copolymer is 100,000-300,000 and the conjugated diene rubber latex content is 4-10 weight % of the total weight of the composition.

The present invention also provides a method of preparing a thermoplastic resin composition comprising the steps of a) preparing the primary graft copolymer by polymerizing conjugated diene rubber latex core with (metha)acrylic acid alkyl ester compound, aromatic vinyl compound and vinyl cyan compound; b) preparing the secondary copolymer by copolymerizing (metha)acrylic acid alkyl ester compound, aromatic vinyl compound and vinyl cyan compound; and c) mixing the primary copolymer and the secondary copolymer prepared above.

Hereinafter, the embodiments of the present invention will be described in detail with reference to the accompanying drawings.

The composition of the present invention includes the primary copolymer prepared by graft copolymerization of conjugated diene rubber latex having excellent impact resistance with (metha)acrylic acid alkyl ester compound, aromatic vinyl compound and vinyl cyan compound to enhance impact resistance, and the secondary copolymer having excellent scratch resistance by polymerization of (metha)acrylic acid alkyl ester compound, aromatic vinyl compound and vinyl cyan compound.

The primary graft copolymer and the secondary copolymer have weight average molecular weights of 80,000-300,000 and more preferably 80,000-200,000. If the weight average molecular weight of the primary or secondary graft copolymer is less than 80,000, the impact strength of the final product would be reduced. On the contrary, if the weight average molecular weight is more than 300,000, the fluidity would be decreased, making processing difficult.

The weight average molecular weight of the mixture of the primary graft copolymer and the secondary copolymer is preferably 100,000-300,000 and more preferably 100,000-200,000. Less than 100,000 weight average molecular weight of the composition results in a decrease in impact strength of the final product, whereas more than 300,000 weight average molecular weight of the composition reduces fluidity, making processing difficult.

The conjugated diene rubber latex content in the thermoplastic resin composition of the invention is preferably 4-10 weight % for the total weight of the resin composition. The conjugated diene rubber latex is induced to supplement the impact strength of the resin composition. Less than 4 weight % of the rubber latex content reduces the impact strength and more than 10 weight % of the content reduces the hardness and scratch resistance.

The preferable weight ratio of the primary graft copolymer and the secondary copolymer in a thermoplastic resin composition is 25:75-75:25, and 35:65-65:35 is more preferable. When the primary graft copolymer is included at less than 25 weight %, which means the rubber latex content in the final resin composition is decreased, the impact strength is not improved, whereas if the primary graft copolymer is included at more than 75%, the hardness and scratch resistance decrease.

The primary graft copolymer is prepared by graft polymerization with i) 10-20 weight part of conjugated diene rubber latex, ii) 40-80 weight part of (metha)acrylic acid alkyl ester compound, iii) 0-40 weight part of aromatic vinyl compound and iv) 0-20 weight part of vinyl cyan compound.

When the conjugated diene rubber latex content in the primary graft copolymer is less than the above range, the impact strength is reduced, and if the content is more than the above range, the hardness is reduced.

When the contents of (metha)acrylic acid alkyl ester compound, aromatic vinyl compound and vinyl cyan compound are less than the said range, the hardness is reduced, whereas when their contents are more than the said range, the impact strength is also reduced.

The second copolymer is preferably prepared by polymerization with i) 40-80 weight part of (metha)acrylic acid alkyl ester compound, ii) 0-50 weight part of aromatic vinyl compound and iii) 0-30 weight part of vinyl cyan compound. If the contents of these compounds are out of the said range, particularly less than the above, the hardness of the composition is decreased, whereas if the contents are more than the above range, the impact strength is reduced.

To enhance the impact strength, the conjugated diene rubber latex included in the primary graft copolymer is preferably one of butadiene rubber latex, styrene-butadiene copolymerized rubber latex or a mixture thereof.

The (metha)acrylic acid alkyl ester compound used for the polymerization of the primary graft copolymer and the secondary copolymer is preferably one or more compounds selected from a group consisting of (metha)acrylic acid methyl ester, (metha)acrylic acid ethyl ester, (metha)acrylic acid propyl ester, (metha)acrylic acid 2-ethyl hexyl ester, (metha)acrylic acid decyl ester and (metha)acrylic acid lauryl ester, and among those compounds methyl methacrylate (MMA), which is a (metha)acrylic methyl ester, is most preferred.

The aromatic vinyl compound used for the polymerization of the primary graft copolymer and the secondary copolymer is one or more compounds selected from a group consisting of styrene, a-methyl styrene, p-methyl styrene and vinyl toluene, and among those compounds, styrene is most preferred.

The vinyl cyan compound used for the polymerization of the primary graft copolymer and the secondary copolymer is preferably acrylonitrile, methacrylonitrile or a mixture thereof.

The primary graft copolymer prepared by polymerization of the above compounds preferably has a core-shell structure comprising i) conjugated diene rubber latex core and ii) a shell obtained from the polymerization of (metha)acrylic acid alkyl ester compound, aromatic vinyl compound and vinyl cyan compound.

FIG. 1 is a diagram illustrating the cross section of the primary graft copolymer (10) composed of the rubber latex core (11) and the shell (12) covering the core.

The conjugated diene rubber latex core of the primary graft copolymer preferably has an average particle diameter of 80-350 nm, a gel content of 50-95%, and a swelling index of 10-20 to enhance the impact strength of the thermoplastic resin.

The thermoplastic resin composition of the present invention can additionally include silicon oil, if necessary. The silicon oil improves the scratch resistance of the resin composition and the preferable content of the silicon oil is 0-5 weight part for 100 weight part of the resin composition. More than 5 weight part of the silicon oil causes extra silicon oil to flow out of the resin composition.

The silicon oil is preferably polydimethylsiloxane, polymethylphenylsiloxane, or a mixture thereof. The preferable viscosity of the silicon oil is up to 10,000 cps.

FIG. 2 is a diagram illustrating the cross section of a thermoplastic resin composition (20) in which the primary graft copolymer (10) is dispersed on the secondary copolymer matrix (21).

The thermoplastic resin composition of the present invention with the structure above has a hardness of at least 115 (R-scale), which is the hardness level of an HB pencil, and an impact strength of at least 7 kg·cm/cm. It is more preferable for the thermoplastic resin composition to have a hardness of 115-125 (R-scale), which is the hardness level of an HB or H pencil, and an impact strength of 7-10 kg·cm/cm.

Owing to its excellent impact resistance and scratch resistance, the thermoplastic resin composition of the present invention can be used as a housing material not only for electrical appliances such as refrigerators, washers, TVs or air-conditioners, etc, but also office machines such as PDPs, LCDs, OLEDs, monitors, computers, copy-machines or telephones, etc. The applicable fields are not limited thereto.

The preparation method of the thermoplastic resin composition of the present invention consists of the following steps: a) preparing the primary graft copolymer by polymerizing conjugated diene rubber latex with (metha)acrylic acid alkyl ester compound, aromatic vinyl compound and vinyl cyan compound; b) preparing the secondary copolymer by copolymerizing (metha)acrylic acid alkyl ester compound, aromatic vinyl compound and vinyl cyan compound; and c) mixing the primary copolymer and the secondary copolymer prepared above.

A polymerization method for preparing the primary graft copolymer is not limited to a specific method, and emulsion polymerization or bulk polymerization is preferably employed. Considering an enhanced grafting effect, the gloss of the final product and the size of the primary graft copolymer particle, emulsion polymerization is more preferred.

In the step of preparing the primary graft copolymer, the weight average molecular weight of the primary graft copolymer is preferably adjusted to 80,000-300,000 by adding a molecular weight regulator. The molecular weight regulator is selected from among mercaptan compounds such as di-t-dodecylmercaptan, n-dodecylmercaptan or t-dodecylmercaptan, etc.

A polymerization method for the secondary copolymer is not limited to a specific method either, and emulsion polymerization, suspension polymerization or bulk polymerization is used. In the case of polymerization in water such as emulsion polymerization or suspension polymerization, the remaining emulsifying agent or dispersing agent in the resin composition reduces the hardness. Therefore, bulk polymerization is more preferred if superior hardness and scratch resistance are wanted.

In the step of preparing the secondary copolymer, the weight average molecular weight of the secondary copolymer is preferably adjusted to 80,000-300,000 by adding a molecular weight regulator. The molecular weight regulator is selected from among mercaptan compounds such as di-t-dodecylmercaptan, n-dodecylmercaptan or t-dodecylmercaptan, etc.

The preferable mixing ratio of the primary graft copolymer to the secondary copolymer is 25:75-75:25.

The preparation method of the thermoplastic resin composition of the present invention can include an additional step of adding silicon oil in step c) by 0-5 weight part for 100 weight part of the primary graft copolymer and the secondary copolymer complex.

Descriptions on conjugated diene rubber latex, (metha)acrylic acid alkyl ester compound, aromatic vinyl compound, vinyl cyan compound and silicon oil used in the preparation method of the thermoplastic resin composition of the present invention have been made hereinbefore, and thus will not be repeated hereinafter.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a diagram illustrating the cross section of the primary graft copolymer.

FIG. 2 is a diagram illustrating the structure of the resin composition of the present invention.

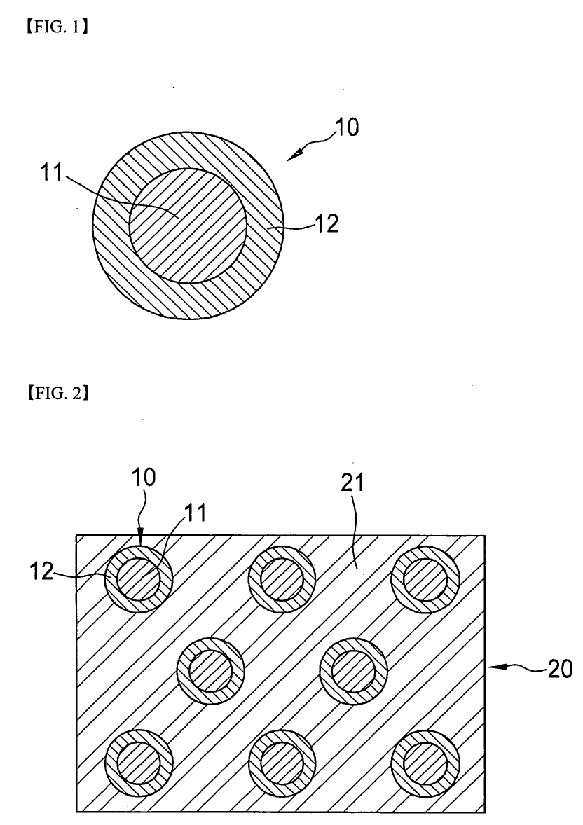

### BEST MODES FOR CARRYING OUT THE INVENTION

Practical and presently preferred embodiments of the present invention are illustrated as shown in the following Examples.

However, it will be appreciated that those skilled in the art, on consideration of this disclosure, may make modifications and improvements within the spirit and scope of the present invention.

### EXAMPLES

GPC was used to measure the weight average molecular weight and calibration was carried out using a PMMA standard sample to determine the molecular weight.

### Preparative Examples A-1-A-5

### Preparation of the Primary Graft Copolymer

The components listed in Table 1 were mixed according to the contents shown in Table 1, which were serially placed in a reactor, followed by reaction at 75° C. for 5 hours. Upon completion of the reaction, the temperature of the reactor was raised to 80° C., followed by aging for one hour. Then, the reaction was terminated.

The reaction product was solidified in calcium chloride solution, washed and prepared as the primary graft copolymer powder.

TABLE 1
Unit: Weight part

| | | A-1 | A-2 | A-3 | A-4 | A-5 |
|---|---|---|---|---|---|---|
| Component | Ion exchanging water | 100 | 100 | 100 | 100 | 100 |
| | Rubber latex | 16 | 16 | 16 | 40 | 16 |
| | Methylmethacrylate | 60 | 30 | 60 | 40 | 60 |
| | Styrene | 20 | 50 | 20 | 16 | 20 |
| | Acrylonitrile | 4 | 4 | 4 | 4 | 4 |
| | Sodium oleate emulsifier | 0.5 | 0.5 | 0.5 | 0.5 | 0.5 |
| | t-dodecylmercaptan | 0.3 | 0.3 | 0.7 | 0.3 | 0.05 |
| | Sodium pyrophosphate | 0.048 | 0.048 | 0.048 | 0.048 | 0.048 |
| | Dextrose | 0.012 | 0.012 | 0.012 | 0.012 | 0.012 |
| | Ferrous sulphide | 0.001 | 0.001 | 0.001 | 0.001 | 0.001 |
| | Cumene hydroperoxide | 0.04 | 0.04 | 0.04 | 0.04 | 0.04 |
| Product | Weight average molecular | 150K | 150K | 70K | 150K | 300K |
| | weight | | | | | |

In Table 1, the rubber latex is a butadiene rubber latex prepared by emulsion polymerization and which has an average diameter of 300 nm and a gel content of 70%.

### Preparative Examples B-1-B-4

### Preparation of the Secondary Copolymer

The compounds listed in Table 2 were serially added to a reactor and mixed therein according to the contents as shown in Table 2, followed by reaction for three hours, during which the reaction temperature was maintained at 140° C.

The polymerization solution prepared in the above reactor was heated in a preheating chamber, and non-reacted monomers were volatilized in a volatilizing chamber. The reaction temperature was maintained at 210° C. by using a polymer transfer pump extruder to prepare the secondary copolymer pellet.

TABLE 2
Unit: Weight part

| | | B-1 | B-2 | B-3 | B-4 |
|---|---|---|---|---|---|
| Component | Toluene | 30 | 30 | 30 | 50 |
| | Methylmethacrylate | 70 | 40 | 70 | 70 |
| | Styrene | 25 | 55 | 25 | 25 |
| | Acrylonitrile | 5 | 5 | 5 | 5 |
| | Di-t-dodecylmercaptan | 0.15 | 0.15 | 0.5 | 0.05 |
| Product | Weight average | 150K | 150K | 60K | 300K |
| | molecular weight | | | | |

In Table 2, the toluene was added as a solvent and the di-t-dodecylmercaptan was added as a molecular weight regulator.

### Examples 1-4, and Comparative Examples 1-4

According to the composition as shown in Table 3, the primary graft copolymer, the secondary copolymer and silicon oil were mixed, to which a lubricant and an antioxidant were added. As a result, the pellet form resin composition was prepared in a 220° C. cylinder by using a twin extruding mixer.

TABLE 3

| | Primary graft | | Secondary | | Silicon | | Weight |
|---|---|---|---|---|---|---|---|
| | copolymer | | copolymer | | oil | | average |
| | | Content | | Content | (weight | Rubber latex | molecular |
| | | (weight part) | | (weight part) | part) | (weight %) | weight |
| Example 1 | A-1 | 50 | B-1 | 50 | 0 | 8 | 150,000 |
| Example 2 | A-1 | 50 | B-1 | 50 | 1 | 8 | 150,000 |
| Example 3 | A-1 | 35 | B-1 | 65 | 0 | 5.6 | 135,000 |
| Example 4 | A-5 | 50 | B-4 | 50 | 0 | 8 | 300,000 |
| Comparative | A-2 | 50 | B-2 | 50 | 0 | 8 | 110,000 |
| Example 1 | | | | | | | |
| Comparative | A-3 | 50 | B-3 | 50 | 0 | 8 | 65,000 |
| Example 2 | | | | | | | |
| Comparative | A-4 | 60 | B-1 | 40 | 0 | 24 | 158,000 |
| Example 3 | | | | | | | |
| Comparative | A-4 | 20 | B-1 | 80 | 0 | 8 | 166,000 |
| Example 4 | | | | | | | |

The pellet was injected to prepare samples. The physical properties of the samples were measured and the results are shown in Table 4.

Hardness (Rockwell Hardness, R-scale)

Hardness was measured by ASTM D-785.
Pencil Hardness

Pencil hardness was measured by ASTM D-3356.
Notched Izod Impact Strength

Notched izod impact strength of ¼″ sample was measured by ASTM D-256.

TABLE 4

| | Hardness | | Impact strength |
|---|---|---|---|
| | (R-scale) | Pencil hardness | (kg · cm/cm) |
| Example 1 | 120 | HB | 10 |
| Example 2 | 118 | H | 10 |
| Example 3 | 123 | H | 7 |
| Example 4 | 121 | H | 16 |
| Comparative | 116 | B | 10 |
| Example 1 | | | |
| Comparative | 119 | HB | 3 |
| Example 2 | | | |
| Comparative | 105 | 3B | 20 |
| Example 3 | | | |
| Comparative | 120 | HB | 3 |
| Example 4 | | | |

As shown in Table 4, the resin compositions of Examples 1-4 have a hardness of at least 118, equivalent to that of an HB pencil, and an impact strength of 7 kg·cm/cm, suggesting that the resin compositions have excellent hardness and impact strength. On the other hand, the resin composition of Comparative Example 1 showed reduced hardness level and impact strength since methlymethacrylate, which is not included in the criteria of the present invention, was used.

The resin composition of Comparative Example 2 had a molecular weight of 70,000 during the production of the primary graft copolymer and the secondary copolymer, and the molecular weight of the final product was up to 100,000, indicating that impact strength was rapidly reduced. The resin composition of Comparative Example 3 exhibited low hardness and impact strength since the rubber contents in the primary graft copolymer and in the final product were out of the preferred range of the invention.

The resin composition of Comparative Example 4 could not enhance the impact strength of the final product because the rubber content in the primary graft copolymer was out of the preferred range of the invention.

### INDUSTRIAL APPLICABILITY

The thermoplastic resin composition of the present invention has excellent impact strength, surface gloss, and beautiful color by including a) the primary graft copolymer prepared by polymerization of conjugated diene rubber latex with (metha)acrylic acid alkyl ester compound, aromatic vinyl compound and vinyl cyan compound and b) the secondary copolymer prepared by polymerization of (metha)acrylic acid alkyl ester compound with aromatic vinyl compound and vinyl cyan compound.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A thermoplastic resin composition comprising:
a) the primary graft copolymer prepared by graft-copolymerization of conjugated diene rubber latex with (metha)acrylic acid alkyl ester compound, aromatic vinyl compound and vinyl cyan compound, and having a weight average molecular weight of 80,000-300,000; and
b) the secondary copolymer prepared by polymerization of (metha)acrylic acid alkyl ester compound, aromatic vinyl compound and vinyl cyan compound, and having a weight average molecular weight of 80,000-300,000, in which the weight average molecular weight of the mixture of the primary copolymer and the secondary copolymer is 100,000-300,000 and the conjugated diene rubber latex content is 4-10 weight % of the total weight of the composition.

2. The thermoplastic resin composition according to claim 1, wherein the primary graft copolymer and the secondary copolymer are included at the weight ratio of 25:75-75:25.

3. The thermoplastic resin composition according to claim 1, wherein the primary graft copolymer is prepared by graft-polymerization of
i) 10-20 weight part of conjugated diene rubber latex,
ii) 40-80 weight part of (metha)acrylic acid alkyl ester compound,
iii) 0-40 weight part of aromatic vinyl compound, and
iv) 0-20 weight part of vinyl cyan compound.

4. The thermoplastic resin composition according to claim 1, wherein the secondary copolymer is prepared by polymerization of
i) 40-80 weight part of (metha)acrylic acid alkyl ester compound,
ii) 0-50 weight part of aromatic vinyl compound, and
iii) 0-30 weight part of vinyl cyan compound.

5. The thermoplastic resin composition according to claim 1, wherein the conjugated diene rubber latex is either butadiene rubber latex, or styrene-butadiene copolymer rubber latex, or a mixture thereof.

6. The thermoplastic resin composition according to claim 1, wherein the (metha)acrylic acid alkyl ester compound used for the primary graft copolymer and the secondary copolymer is one or more compounds selected from a group consisting of (metha)acrylic acid methyl ester, (metha)acrylic acid ethyl ester, (metha)acrylic acid propyl ester, (metha)acrylic acid 2-ethyl hexyl ester, (metha)acrylic acid decyl ester, and (metha)acrylic acid lauryl ester

7. The thermoplastic resin composition according to claim 1, wherein the aromatic vinyl compound used for the preparation of the primary graft copolymer and the secondary copolymer is one or more compounds selected from a group consisting of styrene, α-methylstyrene, p-methylstyrene, and vinyl toluene.

8. The thermoplastic resin composition according to claim 1, wherein the vinyl cyan compound used for the polymerization of the primary graft copolymer and the secondary copolymer is either acrylonitrile, methacrylonitrile, or a mixture thereof.

9. The thermoplastic resin composition according to claim 1, wherein the primary graft copolymer is composed of
i) conjugated diene rubber latex core, and
ii) a shell polymerized of (metha)acrylic acid alkyl ester compound, aromatic vinyl compound and vinyl cyan compound.

10. The thermoplastic resin composition according to claim 9, wherein the conjugated diene rubber latex core has an average diameter of 80-350 nm, a gel content of 50-95%, and a swell index of 10-20.

11. The thermoplastic resin composition according to claim 1, wherein c) silicon oil is included by 0-5 weight part for 100 weight part of the resin composition.

12. The thermoplastic resin composition according to claim 1, which is characterized by a hardness of at least 115 (R-scale), equal to that of an HB pencil, and an impact strength of 7 kg·cm/cm.

13. A preparation method of the thermoplastic resin composition comprising the following steps:
a) preparing the primary graft copolymer by polymerizing conjugated diene rubber latex core with (metha)acrylic acid alkyl ester compound, aromatic vinyl compound, and vinyl cyan compound;
b) preparing the secondary copolymer by copolymerizing (metha)acrylic acid alkyl ester compound, aromatic vinyl compound, and vinyl cyan compound; and
c) mixing the primary copolymer and the secondary copolymer prepared above.

14. The preparation method of the thermoplastic resin composition according to claim 13, wherein step c) additionally includes the step of adding silicon oil by 0-5 weight part for 100 weight part of the mixture of the primary copolymer and the secondary copolymer.
